(19) United States
(12) Patent Application Publication
(10) Pub. No.: US 2021/0101404 A1
(43) Pub. Date: Apr. 8, 2021

(54) PATTERNED ART WITH VARIABLE RESIST ZONES

(71) Applicant: CRAYOLA, LLC, Easton, PA (US)

(72) Inventors: Craig Skinner, Easton, PA (US); Jake Towne, Nazareth, PA (US); Anthony P. Monzo, Easton, PA (US)

(21) Appl. No.: 17/062,068

(22) Filed: Oct. 2, 2020

Related U.S. Application Data
(60) Provisional application No. 62/910,700, filed on Oct. 4, 2019.

(51) Int. Cl. B44F 1/10

(52) U.S. Cl. CPC B44F 1/10

(57) ABSTRACT

Aspects herein are directed to a substrate having resist zones adjacent to non-resist zones on a first surface of the substrate that cooperate to define a “hidden” image. The non-resist zones are zones on the substrate that absorb a colored fluid such as ink applied using a marker and the like. The resist zones are zones on the substrate that do not absorb/repel the colored fluid from the substrate such that the colored fluid can be wiped off of the surface the resist zones. Once all the resist zones are cleaned off and the non-resist zones are colored in, the “hidden” image is revealed to a user. Aspects herein are also directed to kits that include, for example, a plurality of substrates that include the properties of the substrate described above, and one or more colored fluid delivery tools, and cleaning tools for wiping the colored fluid from the resist zones.

### CROSS-REFERENCE SECTION

This application claims the benefit of priority to U.S. Provisional Application No. 62/910,700, titled “Concentric Patterned Art with Variable-Width Resist Zones,” and filed Oct. 4, 2019. The entirety of which is incorporated by reference herein.

### BACKGROUND

Coloring systems with “spiral” or “puzzle” line art often include variable width coloring zones that must be carefully filled in to create a desired art output. Such zones may be difficult to follow, mesmerizing to distinguish, and challenging and thus, requiring full concentration to fill in blanks to eventually reveal a hidden image. The activity therefore, may be perceived as tedious, particularly to children or persons having a short attention span. Further, a simple mistake such as incorrectly coloring in a zone meant to be left blank can alter the entire appearance of the artwork and ruin the final output. As such “spiral” or “puzzle” artwork is typically only mastered by very mature artists with a steady hand having the ability to pay attention to minute detail, thereby making “spiral” or “puzzle” artwork inaccessible to young children or people of any age lacking such characteristics.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims as supported by the Specification, including the Detailed Description.

In brief and at a high level, this disclosure describes, among other things, an art system that comprises a substrate surface having a plurality of variable width resist zones and a plurality of variable width non-resist zones that cooperate to form a pattern yielding a recognizable image when the plurality of variable width resist zones are visually contrasted from the plurality of variable width non-resist zones by the application of a contrasting color to the plurality of variable width non-resist zones. This greatly enhances the ability for anyone, including small children, to complete “spiral” or “puzzle” artwork in a fraction of the time generally needed to complete traditional “spiral” or “puzzle” artwork.

Further aspects herein are directed to a drawing surface or substrate surface having a plurality of variable width resist zones that selectively resist absorption of a colored fluid such as, for example, ink onto the drawing surface or substrate surface. The plurality of resist zones are distributed in linear fashion according to continuous lines having variable widths (e.g., thicknesses) along their length. The continuous lines having variable widths along their length can be for example, straight lines, curved lines, zig-zag lines, jagged lines, and the like that can be stacked or that can form spiral patterns, concentric patterns (e.g., different sized shapes enclosed within an edge defining shape sharing the same center). In other words, the continuous lines having variable widths along their length may move in multiple directions to form a generally desired shape, or may move in the same direction in a stacked manner. The different concentric patterns may have any desired shape such as, for example, round, oval, or polygon such as, square, triangle, oval, star, pentagon, hexagon, and the like, or may form organic shapes such as clouds, conversation bubble, and the like.

The disclosure herein further describes, among other things, a kit for creating “spiral” or “puzzle” art that includes one or more fluid-based marking tools and a substrate having a first surface and an opposite second surface, the first surface having a resist material (also referred to as a fluid resistant material) forming a plurality of variable width resist zones on the first surface that mask the first surface of the substrate so that any fluid (e.g., a colored fluid) applied to the first surface does not get absorbed into the substrate at the portions of the substrate that are masked by the plurality of variable width resist zones. The unmasked or plurality of variable width non-resist zones are complementary or fill in the spaces between the continuous lines having variable widths. In other words, each variable width resist zone of the plurality of variable width resist zones is adjacent to or directly next to a variable width non-resist zone. Said differently, the plurality of variable width resist zones are intercalated (e.g., the variable width resist zones alternate with the variable width non-resist zones) with the plurality of variable width non-resist zones such that where a variable width resist zone is wide, the complementary variable width non-resist zone is thin, and vice versa so that they are all fitted within a predefined margin or perimeter, which also defines the margin or perimeter of the “spiral” or “puzzle” art “hidden” image that is to be revealed when color is applied to the plurality of variable width non-resist zones.

In accordance with aspects herein, the “spiral” or “puzzle” art image defined by the plurality of variable width resist zones and the plurality of variable width non-resist zones may be centered on the substrate, or multiple “spiral” or “puzzle” art images may be provided on the same substrate. For example, if the substrate is a rectangular sheet of paper, the “spiral” or “puzzle” art image may be centered on the sheet of paper, may be placed at a location that is not centered on the sheet of paper, may take up the whole sheet of paper, and the like. If a border is provided around the “spiral” or “puzzle” art image(s), the border may further include coloring images that the user may further choose to color. In other aspects, the border may be completely or in part also coated with the resist material so that if the colored fluid is placed in an undesirable location of the substrate, it can be easily removed by wiping off the substrate to provide a clean finalized “spiral” or “puzzle” art image(s) on the substrate or sheet of paper.

In further aspects, portions of the variable width non-resist zones (e.g., untreated zones or non-coated zones) may be marked with a colored fluid such as an ink, while the variable width resist zones may remain unmarked based on resisting the absorption of the ink. In some instances, ink that is not absorbed in the variable width resist zones (e.g., pooling ink) can be subsequently removed, for example, by wiping the variable width resist zones with a textile that absorbs the ink. As such, a user may apply a colored fluid, via a delivery mechanism such as a marker, to the entire drawing substrate without having to differentiate or concentrate on staying between the lines. Since the variable width resist zones repel or resist absorption of the colored fluid, a coloring amount of the colored fluid is only delivered and absorbed into the variable width non-resist zones of the substrate. In other words, aspects disclosed herein facilitate selective coloring without the user having to be selective about where the color is being applied to because the user may easily remove any residual ink from the resist zones by wiping the substrate and thereby quickly revealing an image that was hidden in the pattern formed by the cooperation of the plurality of variable width resist zones and the plurality of variable width non-resist zones arranged on a coloring surface of the substrate.

The substrate surface (e.g., a drawing surface) may include materials that are able to absorb a colored fluid such that a dye in the colored solution is retained by the material. Example materials include paper, fabrics or textiles, cardboard, polymer films, and the like. The material of the substrate may also be any material that is able to receive a resist material. The resist material may be applied to the surface of the substrate surface by, for example, printing, stamping, plate printing, and the like, and then cured depending on the type of resist material used. In one example, the resist material may include, for example, a UV release coating that is cured onto the surface by exposing the substrate surface treated with the UV release coating to a UV light source. The substrate surface may, for example, have a smoothness or roughness that may be measured by standard tests such as, for example, the Sheffield method that generally measures surface smoothness or the Parker Print Surf method that generally measures surface roughness. For example, in some aspects, the substrate surface may be a sheet of paper having a surface roughness, as measured by the Parker Print Surf method, of about 1.70 and 2.00, where the term “about” indicates a deviation of ±0.01. In other aspects, the surface roughness may be between about 1.74 to about 1.95, between about 1.80 to about 1.91, or between about 1.84 to about 1.90. The smoothness or roughness of the substrate surface may improve the adhesion of the resist material to the substrate surface and may also play a role in how the colored fluid behaves or is absorbed by the substrate surface. In other embodiments, the pre-printed substrate is a paper surface capable of receiving ink on uncoated surfaces. In further aspects, the substrate may be a paper having a basis weight from about 50 g/m² to about 350 g/m², where the term “about” means that there may be deviation of ±1 g/m². The basis weight may further be from about 100 g/m² to about 345 g/m², from about 150 g/m² to about 340 g/m2, from about 200 g/m² to about 340 g/m2, and from about 216 g/m² to about 325 g/m², depending on the type of application desired. In further aspects, the thickness of the substrate may have a thickness of about 50 microns to about 320 microns, where the term “about” means that there may be a deviation of ±1 micron. The thickness may further be from about 80 microns to about 310 microns, from about 120 microns to about 305 microns, from about 150 microns to about 300 microns, from about 170 microns to about 315 microns, from about 180 microns to about 310 microns, and from about 190 microns to about 307 microns, depending on the type of application desired.

The resist material used to form the resist zones on the drawing surface or substrate surface may be a material that repels or resists absorption of a colored fluid. The colored fluid in accordance with aspects herein, may be comprised of at least a dye and a solvent. Solvents may include, for example, water, alcohol, oil, and the like from which a colored fluid can be formed by dissolving an amount of color dye into a predetermined amount of solvent. For example, in an aqueous colored fluid, the solvent used of dissolving the dye may be comprised of at least water. Thus, in one example where the colored fluid is aqueous or water-based, the resist material may be comprised of a hydrophobic material that repels the water in the water-based colored fluid. In other words, the colored fluid sits on the surface of the resist material, for example, by beading on the surface of the resist material. This “beading” is largely a property of the fluid that can be measured by the surface tension of the fluid, which is the tendency of liquid surfaces to shrink into the smallest surface area possible. For example, at room temperature, which is generally between 20° C. and 25° C., the surface tension of water is between 72.8 mN m⁻¹±0.05 and 71.99 mN m⁻¹±0.05. The dyes in the water-based inks may reduce the surface tension of water by about 5 mN m⁻¹ to about 18 mN m⁻¹, where the term “about” signifies that there may be a deviation of ±0.05 mN m⁻¹.

Water-based colored fluids (e.g., inks or paints) may be applied to the substrate using marking tools such as, for example, markers, brushes, pens, and the like. In one example, the material being used for the resist material may include, for example, a UV release coating. In aspects herein, the resist material may be a clear (e.g., transparent) material that blends in with (e.g., takes on) the color of the substrate surface. In other aspects, the resist material may be a translucent or an opaque material that is tinted (or colored) to a similar color as the substrate surface. The resist material may be a similar color based on having a corresponding hue (red, green, blue, yellow, etc.) as the color of the substrate surface, as perceived by a human. For example, if the substrate surface is black, the resist material may also be black. In other aspects, the resist material may be a color that contrasts with the color of the substrate surface, depending on the visual effects desired in the final revealed image once color is applied to the substrate portions that are not treated with the resist material.

The term “image” as used herein, refers to a physical likeness or representation of a person, animal, or thing, photographed, painted, sculptured, or otherwise made visible or that can be visually perceived at a glance. A “hidden” image, as used herein means that the image is not visible or cannot be visually perceived at a glance. The term “multi-directional” or “multiple directions” as used herein refers to a line that changes direction at least once by making a turn along its path. For example, to draw a square on a 2D surface, a person may start by drawing a line moving their pencil to the right of a starting point, then change direction and continue drawing the line moving their pencil downwardly, then change direction and continue drawing the line to going to the left and finally, change direction again and continue drawing the line upwardly back toward the starting point. The term “substrate” as used herein refers to an underlying layer of material having a surface. The term “spiral” as used herein refers to a continuous and gradually widening (or tightening) line that winds around (e.g., surrounds) a central point or area on a 2D surface.

### BRIEF DESCRIPTION OF THE DRAWINGS

Aspects herein will be described in detail below with reference to the attached drawings figures, wherein:

FIG. 1 is shows an exemplary substrate surface having a plurality of variable width resist zones and a plurality of variable width non-resist zones arranged in a circular spiraling pattern to define a “hidden” image, in accordance with aspects herein;

FIG. 2 shows a cross-section of the substrate shown in FIG. 1, taken along line 2-2 in FIG. 1, in accordance with aspects herein;

FIG. 3 is an action representation of a user applying a colored fluid to the substrate surface of FIG. 1, in accordance with aspects herein;

FIG. 4 is an action representation of a user removing any excess colored fluid from the substrate surface of FIG. 3, in accordance with aspects herein;

FIG. 5 depicts the substrate surface of FIG. 1 after the colored fluid has been applied to the plurality of variable width non-resist zones and wiped off of the plurality of variable width resist zones to reveal the “hidden” image, in accordance with aspects herein;

FIG. 6 depicts another exemplary substrate surface having the plurality of variable width resist zones and the plurality of variable width non-resist zones arranged in a fingerprint type of pattern, in accordance with aspects herein;

FIG. 7 depicts yet another exemplary substrate surface having the plurality of variable width resist zones and the plurality of variable width non-resist zones arranged in a square spiraling pattern, in accordance with aspects herein;

FIG. 8 depicts a different exemplary substrate surface having the plurality of variable width resist zones and the plurality of variable width non-resist zones arranged in a pattern of concentric shapes, in accordance with aspects herein; and

FIG. 9 depicts another different exemplary substrate surface having the plurality of variable width resist zones and the plurality of variable width non-resist zones arranged in a pattern of stacking lines, in accordance with aspects herein.

### DETAILED DESCRIPTION

The subject matter of the present invention is described with specificity herein to meet statutory requirements. However, the description itself is not intended to limit the scope of this disclosure. Rather, the inventors have contemplated that the claimed or disclosed subject matter might also be embodied in other ways, to include different steps or combination of steps, components or combinations of components similar to the ones described in this document, in conjunction with other present or future technologies. Moreover, although the terms “step” and/or “block” might be used herein to connote different elements of methods employed, the terms should not be interpreted as implying any particular order among or between various steps disclosed unless and except when the order of individual steps is explicitly stated.

Aspects herein describe art systems including a substrate surface for generating “spiral” or “puzzle” art using variable width resist zones, which are areas of the substrate surface that are coated or treated with a resist material that resists absorption or repels colored fluid materials from their surface. In further aspects, the substrate surface has a plurality of variable width line indicators or variable width resist zones that resist absorption of a colored fluid such as, for example, water-based inks, onto the substrate surface at the plurality of variable width line indicators or variable width resist zones. Areas of the substrate surface that are not covered or are not coated (e.g., are not treated with the resist material) define variable width non-resist zones that are arranged so that they are adjacent to the variable width resist zones in a side-by-side arrangement in an alternating manner forming a pattern that can be comprised of a plurality of concentric shapes of different sizes, a spiraling pattern, a stacking line pattern, and the like, that may facilitate the creation of a “spiral” or “puzzle” art image.

Further aspects provide a kit for creating “spiral” or “puzzle” art images with one or more colored fluid marking instruments, and a substrate surface having a plurality of variable width resist zones and a plurality of variable width non-resist zones. As such, a user may apply a colored fluid (e.g. a water-based ink), via a delivery mechanism such as a marker, to the entire substrate surface, thereby imparting a coloring amount of colored fluid to only the plurality variable width non-resist zones, without having to pay attention to detail to “stay within the lines.” In other words, aspects described herein facilitate selective coloring in of variable zones while only the non-treated zones accept coloring. A user may then remove any residual ink from the plurality of variable width resist zones by wiping using a cloth or paper wipe, or a similar object, to quickly reveal an image that is hidden inside the pattern formed by the plurality of variable width resist zones and the plurality of variable width non-resist zones.

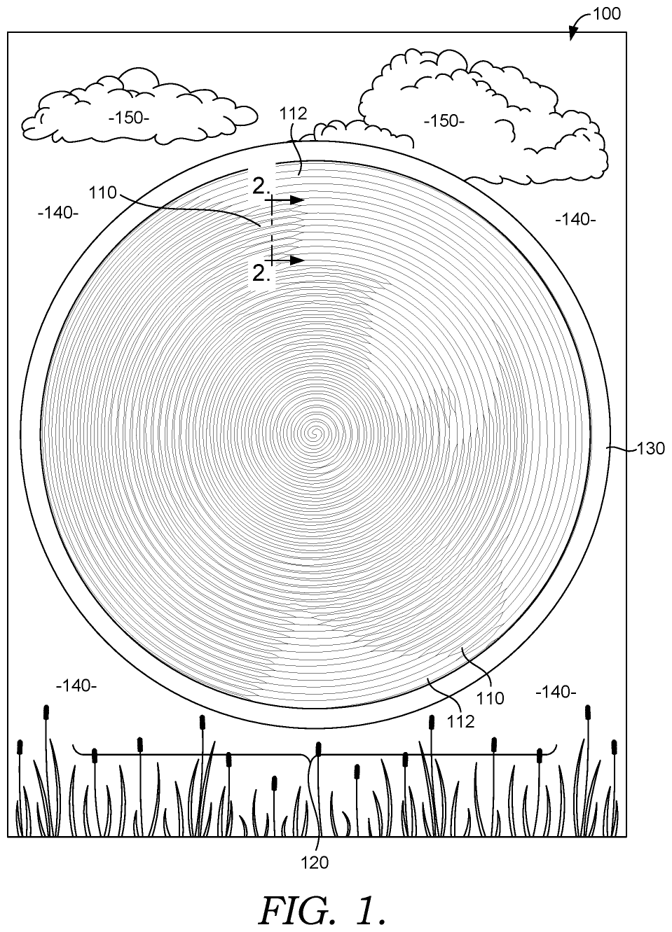

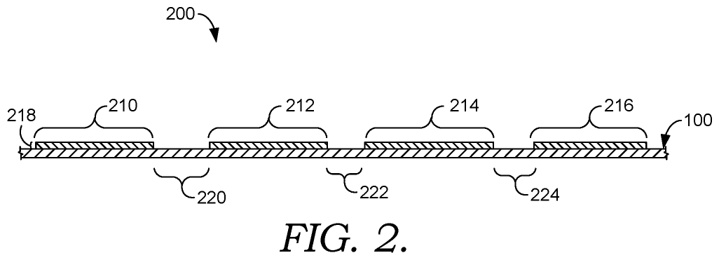

FIG. 1 depicts an uncolored substrate surface 100 having a plurality of variable width resist zones 110 and a plurality of variable width non-resist zones 112 cooperating to form or arranged in a spiraling pattern 120. The spiraling pattern 120 defines a “hidden” image that can be revealed by applying color to the substrate surface 100 so that the color is taken or is absorbed onto the substrate surface 100 at the plurality of variable width non-resist zones 112. The various resist zones in the plurality of variable width resist zones 110 have different widths 210, 212, 214, 216, and so on (as shown in FIG. 2, which represents a cross-sectional view of the substrate surface 100 along the line 2-2 in FIG. 1) at different portions of the spiraling pattern 120. This results in the various non-resist zones in the plurality of variable width non-resist zones 112, also having different widths 220, 222. 224, and so on (as shown in FIG. 2). Because each variable width resist zone 110 in the plurality of variable width resist zones 110 is adjacent to a variable width non-resist zone in the plurality of variable width non-resist zones 112, the plurality of variable width resist zones 110 are complementary to the plurality of variable width non-resist zones 112, and vice versa, to occupy a set space on the substrate surface 100 defined, for example, by the margin 130. In other words, the plurality of variable width non-resist zones 112 make up the spaces between each resist zone in the plurality of variable width resist zones 110 separating the plurality of variable width resist zones from each other. Therefore, each non-resist zone in the plurality of variable width non-resist zones 112 is adjacent to a resist zone in the plurality of variable width resist zones 110 in a side by side arrangement. Additionally, because the plurality of variable width non-resist zones 112 make up the spaces or gaps between the plurality of variable width resist zones 110, where a resist zone widens, a corresponding non-resist zone becomes narrower and vice versa. Further, as shown, optionally, the portions 140 of the substrate surface 100 not occupied by the spiraling pattern 120 enclosed within the margin 130 may be further provided with coloring images 150 for adornment, or the images may already be finalized with color or gray scale. Alternatively, the portions 140 may be blank portions so that a user can have a choice as to how to use the blank space by, for example, creating their own personal decorative art.

As shown in FIG. 2, the plurality of variable width resist zones 110 are applied and adhered to the substrate surface 100 like a coating or laminate that is cured or otherwise fixed onto the substrate surface 100. Thus, the plurality of variable width resist zones 110 extend out from the substrate surface 100 and therefore have a height 218 which is the thickness of the resist material of the plurality of variable width resist zones 110. The height 218 of the plurality of variable width resist zones 110 may range from about 15 microns to about 320 microns, where the term “about” means that there may be a deviation of ±1 micron. The thickness may further be from about 40 microns to about 300 microns, from about 70 microns to about 250 microns, and from about 90 microns to about 200 microns, depending on the type of application desired. Depending on the height of the plurality of variable width resist zones 110, the perceptibility of the plurality of variable width resist zones 110 by vision or touch may be increased or decreased, wherein the smaller the height, the less perceptible the plurality of variable width resist zones 110 may become. Particularly if the resist material forming the plurality of variable width resist zones 110 has a glossiness property that is similar to the substrate surface 100, and is either clear or a color that matches (e.g., a similar human-perceived hue, such as red, green, blue, etc.) the color of the substrate surface 100. As such, as described briefly above, The plurality of variable width resist zones 110 may be made to closely match and blend in with the substrate surface 100 by being transparent (i.e. clear or translucent) or by matching the color of the substrate surface 100, to enhance the hiding factor of the “hidden” image. Alternatively, the plurality of variable width resist zones 110 may be made to contrast with the substrate surface 100 to give the finalized art piece or revealed image a desired color effect. As described above the substrate surface 100 may be formed of a paper provided in sheet form having a basis weight from about 200 g/m² to about 350 g/m², where the term “about” means that there may be deviation of ±1 g/m². The basis weight may further be from about 210 g/m² to about 340 g/m², and from about 216 g/m² to about 325 g/m², depending on the type of application desired. In further aspects, the thickness of the substrate may have a thickness of about 150 microns to about 320 microns, where the term “about” means that there may be a deviation of ±1 micron. The thickness may further be from about 170 microns to about 315 microns, from about 180 microns to about 310 microns, and from about 190 microns to about 307 microns, depending on the type of application desired.

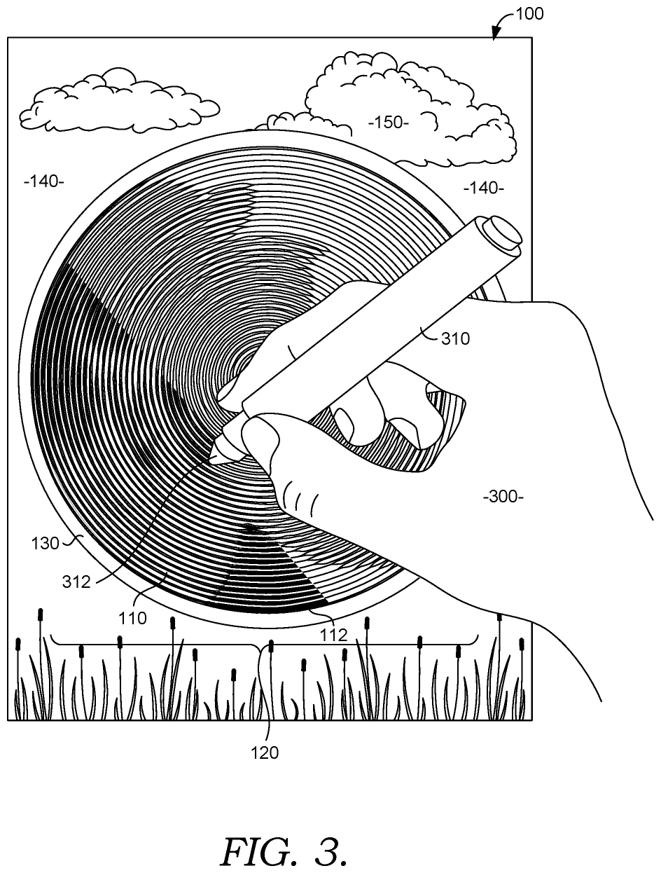

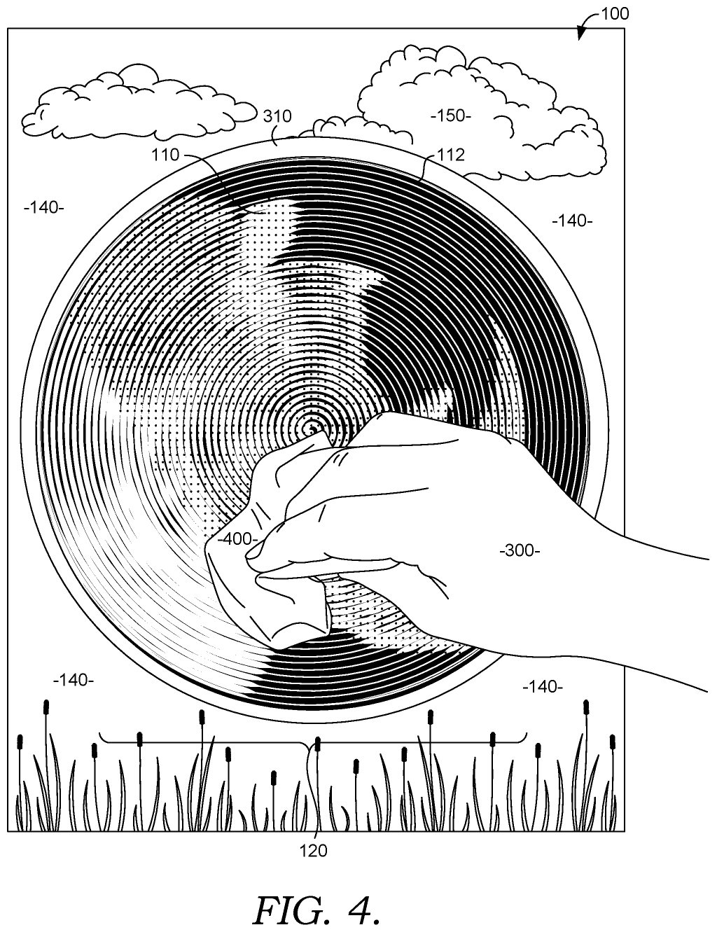

FIG. 3 depicts an action of a user a 300 applying a colored fluid to the substrate surface 100 with a marking tool 310. In FIG. 3, the marking tool 310 is a marker having a marker tip 312 delivering the colored fluid (e.g., solvent based ink such as a water based ink) to the spiraling pattern 120 formed by the plurality of variable width resist zones 110 and the plurality of variable width non-resist zones 112 on the substrate surface 100. Although showing a marker as the marking tool 310, it is contemplated that any other tool useable to deliver a colored fluid to the substrate surface 100 may be used such as, for example, a brush, a pen, and the like. As shown, the user 300 is able to apply the colored fluid onto the spiraling pattern 120 without having to discriminate between the plurality of variable width resist zones 110 and the plurality of variable width non-resist zones 112. To reveal the “hidden” image, as shown in FIG. 4, the user 300 simply needs to wipe off any excess colored fluid that has not been taken or absorbed by the plurality of variable width non-resist zones 112 and is sitting on the surface of the plurality of variable width resist zones 110. The user 300 can accomplish the task of wiping off excess colored fluid from the substrate surface 100 by rubbing a cleaning/wiping wipe, cloth, paper, or tissue 400 against the substrate surface 100.

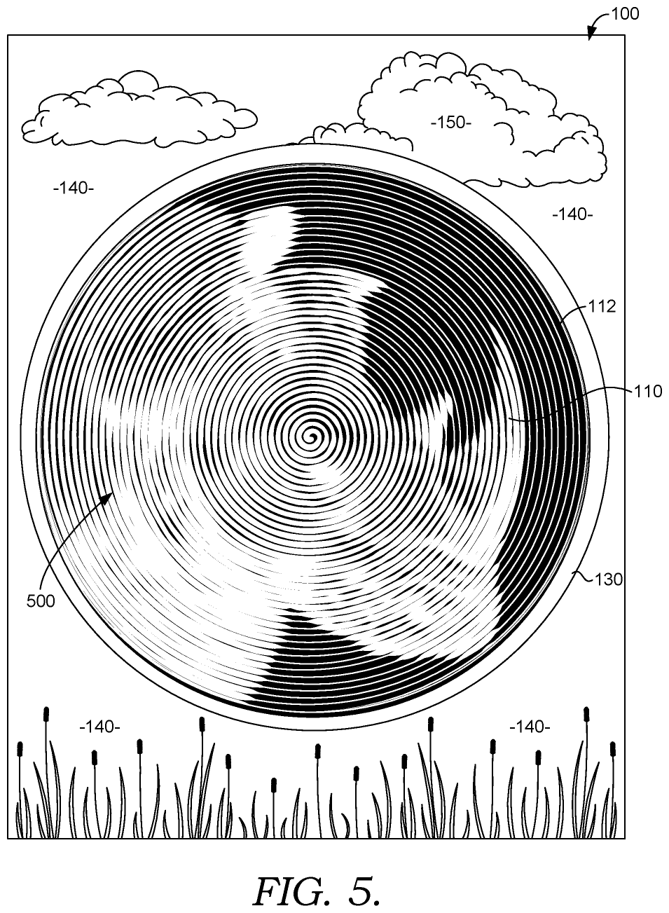

Once the colored in spiraling pattern 120 is cleaned off from excess colored fluid, as shown in FIG. 4, the “hidden” image is revealed as image 500, as shown in FIG. 5. As shown in FIG. 5, the plurality of variable width resist zones 110 and the plurality of variable width resist zones 112 cooperate to form intricate patterns that can also provide intricate details including shadowing effects in the revealed image 500, all with minimal effort from the user 300. In order to ensure that the colored fluid application stays within the spiraling pattern 120, the margin 130 may also be coated with the resist material forming the plurality of variable width resist zones 110.

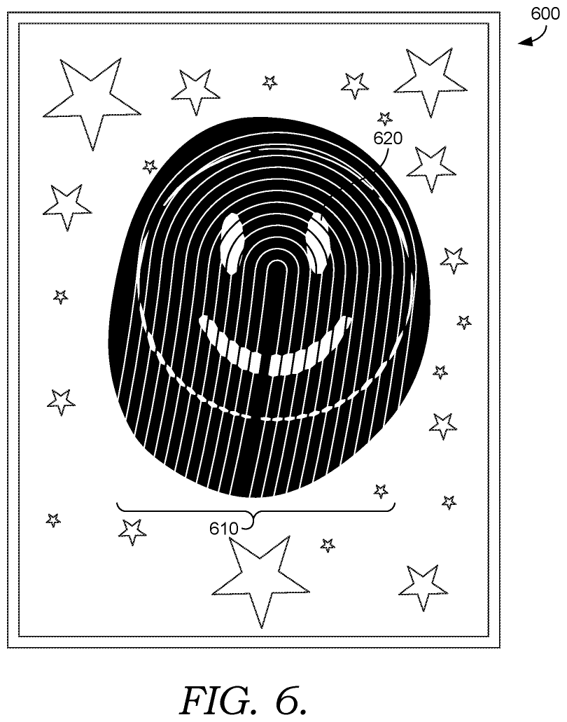

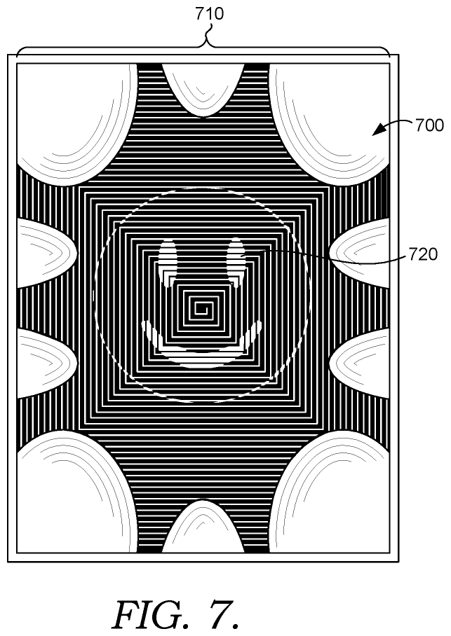

Although the example described in FIGS. 1 to 5 depicts a spiraling pattern 120, it is contemplated that the plurality of variable width resist zones and the plurality of variable width non-resist zones may be arranged in any desirable pattern. Some exemplary alternative patterns with revealed images are shown in FIGS. 6-9. For example, FIG. 6 shows an organic pattern 610 on substrate surface 600, where the pattern 610 resembles a fingerprint hiding an image 620. FIG. 7 shows a pattern having a geometric spiraling pattern 710 on the substrate surface 700, hiding an image 720. The patterns in accordance with aspects herein can take on any type of shape (i.e., circular, geometric with different numbers of sides, organic, oval, and the like) without departing from aspects disclosed herein.

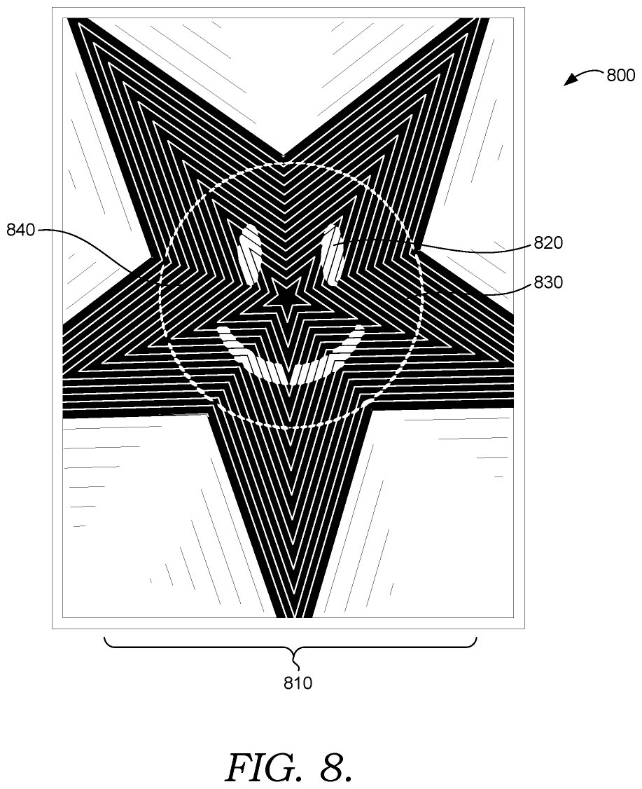

As shown in FIG. 8, the plurality of variable width resist zones 820 and the plurality of variable width non-resist zones 830 may form pattern 810 with a plurality of concentric shapes, on the substrate surface 800 that hides image 840. Again, although the plurality of concentric shapes forming the pattern 810 are shown as stars, it is contemplated that any shape may be used such as organic, geometric with different numbers of sides, circular, oval, and the like, without departing from aspects herein.

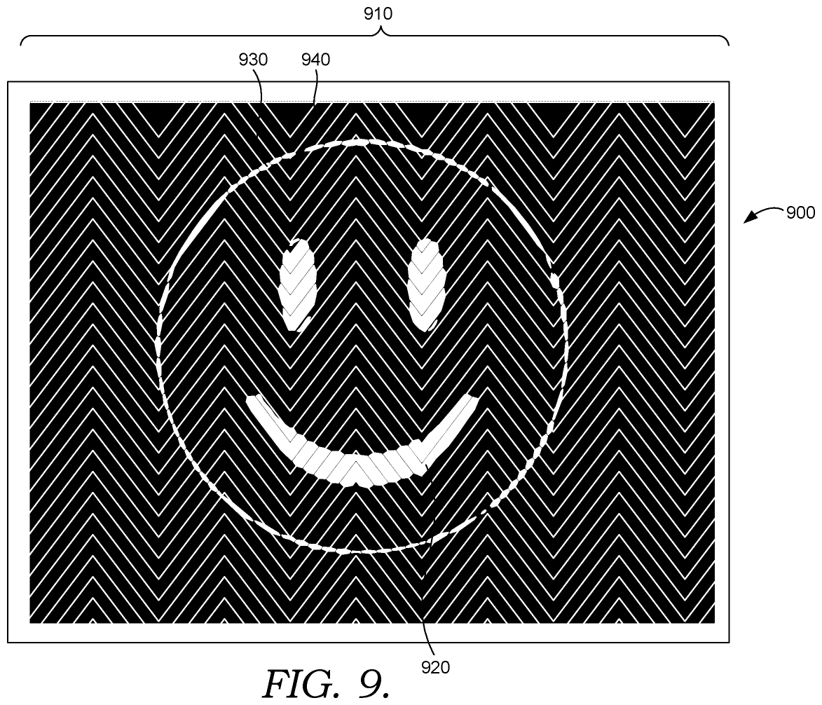

FIG. 9 shows yet another exemplary pattern 910 formed on substrate surface 900 where the plurality of variable width resist zones 930 are provided as lines that are stacked onto the plurality of variable width non-resist zones 940 in an alternating manner, hiding image 920. The stacked plurality of variable width resist zones 930 and the plurality of variable width non-resist zones 940, although shown as forming zig-zag lines, it is also contemplated that the line pattern may include straight lines, curved lines, wavy lines, and the like, without departing from aspects disclosed herein.

In some respects, a kit may be provided that includes a bundle of sheets having a substrate surface, as described. The sheets may be bound or unbound. Additionally, the sheets may include a sheet or booklet with instructions, markers or other coloring tool that is able to deliver a colored fluid. The kits described herein may include, for example, one or more water-based markers and the resist material may for example be a hydrophobic resist material. However, if a different type of ink or coloring fluid is to be used, the resist material forming the plurality of resist zones will be matched to resist penetration of the type of coloring fluid being used. As such, embodiments of the kits discussed herein that utilize a particular type of colored fluid and corresponding resist material may refer to a number of different inking systems and corresponding resist materials that, when applied to a marking substrate, facilitate the easy application of the colored fluid only to desired areas of a substrate surface patterned with a plurality of variable width resist zones and a plurality of variable width non-resist zones.

Aspects of the present disclosure have been described with the intent to be illustrative rather than restrictive. Alternative aspects will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

What is claimed is:

1. An art system comprising:
a substrate having a first surface and an opposite second surface;
a resist material forming a plurality of variable width resist zones on the first surface of the substrate; and
a plurality of variable width non-resist zones, wherein the variable width non-resist zones are arranged adjacent to the variable width resist zones.

2. The art system of claim 1, wherein a color of the resist material blends in with a color of the first surface of the substrate.

3. The art system of claim 1, further comprising a colored fluid marking tool enclosing a colored fluid, wherein the colored fluid marking tool is configured to deliver the colored fluid to the first surface of the substrate.

4. The art system of claim 3, wherein the colored fluid is comprised of a water-based ink.

5. The art system of claim 3, wherein the colored fluid marking tool is one of a marker, a pen, or a brush.

6. The art system of claim 1, wherein at least one of the plurality of variable width resist zones and at least one of the plurality of variable width non-resist zones extend continuously around a center portion of the substrate.

7. The art system of claim 1, wherein the plurality of variable width resist zones and the plurality of variable width non-resist zones cooperate to form a spiraling pattern defining a “hidden” image that is revealed when a colored fluid is applied and absorbed by the plurality of variable width non-resist zones.

8. The art system of claim 7, wherein the colored fluid is repelled from the plurality of variable width resist zones.

9. A substrate comprising:
a first surface having and a second surface that is opposite to the first surface;
a resist material forming a plurality of variable width resist zones on the first surface of the substrate; and
a plurality of variable width non-resist zones, wherein the variable width resist zones are arranged adjacent to the variable width non-resist zones.

10. The substrate of claim 9, wherein the substrate is comprised of an absorbent material.

11. The substrate of claim 10, wherein the absorbent material includes one or more of paper based products, fabric/textile products, cardboard products, and cardstock products.

12. The substrate of claim 9, wherein the plurality of variable width resist zones and the plurality of variable width non-resist zones cooperate to form a spiraling pattern defining a “hidden” image, wherein the “hidden” image is revealed when a colored fluid is applied to and is absorbed by the plurality of variable width non-resist zones.

13. The substrate of claim 12, wherein the resist material repels the colored fluid from the first surface of the substrate.

14. The substrate of claim 9, wherein the plurality of variable width non-resist zones and the plurality of variable width non-resist zones cooperate to form a pattern of concentric shapes defining a “hidden” image, wherein the “hidden” image is revealed when a colored fluid is applied to and is absorbed by the plurality of variable width non-resist zones.

15. The substrate of claim 14, wherein the colored fluid is a water-based ink and the resist material is comprised of a hydrophobic surface coating.

16. The substrate of claim 15, wherein the colored fluid is removable from the resist material by wiping with a textile based or paper based absorbent material.

17. The substrate of claim 9, wherein a color of the resist material blends in with a color of the first surface of the substrate.

18. The substrate of claim 9, wherein the plurality of variable width non-resist zones are intercalated with the plurality of variable width resist zones on the first surface of the substrate to form a pattern defining a “hidden” image, wherein the “hidden” image is revealed when a colored fluid is applied to and is absorbed by the plurality of variable width non-resist zones.

19. A substrate comprising:
a plurality of variable width resist zones; and
a plurality of variable width non-resist zones, wherein the plurality of variable width resist zones resist absorption of a colored fluid applied onto the substrate, and wherein the plurality of variable width non-resist zones absorb the colored fluid applied onto the onto the substrate, wherein each variable width resist zone in the plurality of variable width resist zones is adjacent to a variable width non-resist zone in the plurality of variable width non-resist zones in a side-by-side arrangement such that the plurality of variable width resist zones are alternated with the plurality of variable width non-resist zones.

20. The substrate of claim 19, wherein the plurality of variable width resist zones and the plurality of variable width non-resist zones cooperate to define a “hidden” image that is revealed when a colored fluid is applied to the plurality of variable width non-resist zones.
